(19) United States
(12) Patent Application Publication
(10) Pub. No.: US 2017/0153653 A1
(43) Pub. Date: Jun. 1, 2017

(54) PRESSURE REDUCTION VALVE

(71) Applicant: AISAN KOGYO KABUSHIKI KAISHA, Obu-shi (JP)

(72) Inventors: Katsuyuki HATA, Nagoya-shi (JP); Masahiro KOBAYASHI, Toyohashi-shi (JP)

(73) Assignee: AISAN KOGYO KABUSHIKI KAISHA, Obu-shi (JP)

(21) Appl. No.: 15/291,272

(22) Filed: Oct. 12, 2016

(30) Foreign Application Priority Data
Nov. 30, 2015 (JP) 2015-233704

(51) Int. Cl. G05D 16/16

(52) U.S. Cl. CPC G05D 16/166

(57) ABSTRACT

A pressure reduction valve includes: a housing; an inlet and an outlet provided in the housing; a piston movable in the housing; a rod extending from the piston toward the inlet; a rod sliding part where the rod slides in the housing; a valve element provided in the rod; a valve seat to be seated with the valve element; a valve chamber formed around the valve element downstream the valve seat; a pressure control chamber provided between the piston and the housing downstream of the piston to communicate with the outlet; a passage formed in the rod and the piston; a spring to urge the piston and the rod to separate the valve element from the valve seat; and a sealing member provided in the rod sliding part. A wear ring is provided upstream of the seal member to narrow a clearance between the rod sliding part and the housing.

### CROSS-REFERENCE TO RELATED APPLICATIONS

This application is based upon and claims the benefit of priority from the prior Japanese Patent Application No. 2015-233704, filed on Nov. 30, 2015, the entire contents of which are incorporated herein by reference.

### BACKGROUND OF THE INVENTION

Field of the Invention

The present invention relates to a pressure reduction valve used for decompressing high-pressure fluid such as high-pressure gas.

Related Art

Heretofore, as one technique of this type of a valve, for example, a high-pressure regulator which has been described in Japanese Patent Application Publication No. 2010-533268 (JP-A-2010-533268) is known. As shown in a sectional view of FIG. 7, a high-pressure regulator 61 includes: a housing 62; an inlet 63 and an outlet 64 provided on an axial one end and the other end of the housing 62, respectively; a piston 65 provided in the housing 62 in an axially movable state; a rod 65a axially extending from the piston 65 toward the inlet 63; a sliding part 66 formed in the housing 62 along which the rod 65a is configured to slide; a valve element 67 provided on a leading end of the rod 65a; a valve seat 68 configured to allow the valve element 67 to be seated thereon in the housing 62; a valve chamber 69 formed around the valve element 67 downstream of the valve seat 68; a passage 65b defined by the rod 65a and the piston 65 to flow fluid from the valve chamber 69 toward the downstream side of the piston 65; a spring 70 to urge the piston 65 and the rod 65a in a direction to separate the valve element 67 from the valve seat 68; a pressure control chamber 71 provided between the piston 65 and the housing 62 on the downstream side of the piston 65; and a sealing member 72 provided in the sliding part 66. This sealing member 72 is positioned downstream of the valve chamber 69 and upstream of the pressure control chamber 71. This high-pressure regulator 61 is configured such that high-pressure fluid (for example, hydrogen gas) which has been introduced through the inlet 63 is flown to the pressure control chamber 71 via the passage 65b between the valve element 67 and the valve seat 68, and when the fluid pressure in the pressure control chamber 71 is balanced with the urging force of the spring 70, the high-pressure fluid is decompressed and then flown out through the outlet 64.

### SUMMARY OF INVENTION

### Problems to be Solved by the Invention

However, in the high-pressure regulator 61 described in JP-A-2010-533268, when high-pressure fluid suddenly flows from the inlet 63 into the valve chamber 69, for example, the pressure of the fluid has a chance to be applied to the sliding part 66. This application of the pressure results in sudden high pressure acting on the sealing member 72, and thus there is a possibility that the sealing member 72 gets deformed and broken, leading to deterioration in its sealing function. If the sealing function is deteriorated, a part of the fluid might be leaked outside. In some types of fluids, leakage of the fluid is problematic, and therefore it is a very critical issue to ensure the sealing function of the sealing member 72.

The present invention has been made in view of the above circumstance and has a purpose of providing a pressure reduction valve configured to prevent breakage of a sealing member in a sliding part of a rod so that sealing function is ensured.

### Means of Solving the Problems

To achieve the above purpose, one aspect of the present invention provides a pressure reduction valve including: a housing; an inlet and an outlet provided on an axial one end and the other end of the housing, respectively; a piston provided in the housing in an axially movable state; a rod axially extending from the piston toward the inlet; a rod sliding part along which the rod is configured to slide with respect to the housing; a valve element provided on a leading end of the rod; a valve seat configured to be seated with the valve element in the housing; a valve chamber formed around the valve element downstream of the valve seat; a pressure control chamber provided between the piston and the housing on a downstream side of the piston to communicate with the outlet; a passage formed in the rod and the piston to flow fluid from the valve chamber to the pressure control chamber; a spring configured to urge the piston and the rod in a direction to separate the valve element from the valve seat; and a sealing member provided on the rod sliding part, the pressure reduction valve being configured such that fluid introduced from the inlet is flown in the pressure control chamber between the valve element and the valve seat via the passage and when the fluid pressure in the pressure control chamber is balanced with the urging force of the spring, the fluid is decompressed and then flown out of the outlet, wherein the pressure reduction valve further includes a narrowing member placed upstream of the sealing member to narrow a clearance between the rod sliding part and the housing.

### Effects of the Invention

According to the present invention, breakage of the sealing member in the sliding part of the rod configuring the pressure reduction valve is prevented, and thus the sealing function of the sealing member is ensured.

### BRIEF DESCRIPTION OF THE DRAWINGS

FIG. 1 is a sectional view of a pressure reduction valve in a first embodiment;

FIG. 2 is a perspective view of a wear ring in the first embodiment;

FIG. 3 is a graph showing changes in pressure in each part when inrush pressure is applied to a valve chamber of a pressure reduction valve in the first embodiment;

FIG. 4 is a sectional view of a pressure reduction valve in a second embodiment;

FIG. 5 is a sectional view of a pressure reduction valve in a third embodiment;

FIG. 6 is a perspective view of a wear ring in another embodiment; and

FIG. 7 is a sectional view of a pressure reduction valve in a related art.

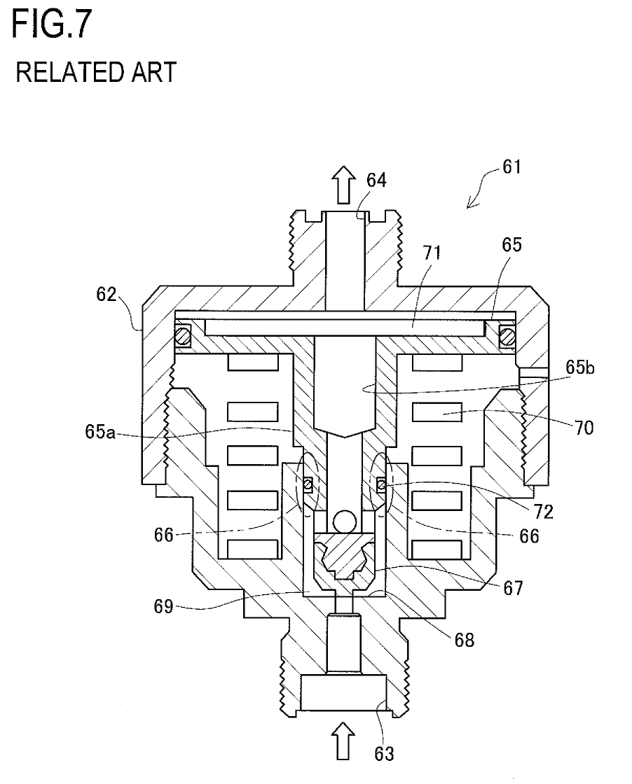

### DESCRIPTION OF EMBODIMENTS

### First Embodiment

A first embodiment embodying a pressure reduction valve of the present invention is now explained in detail below with reference to the accompanying drawings.

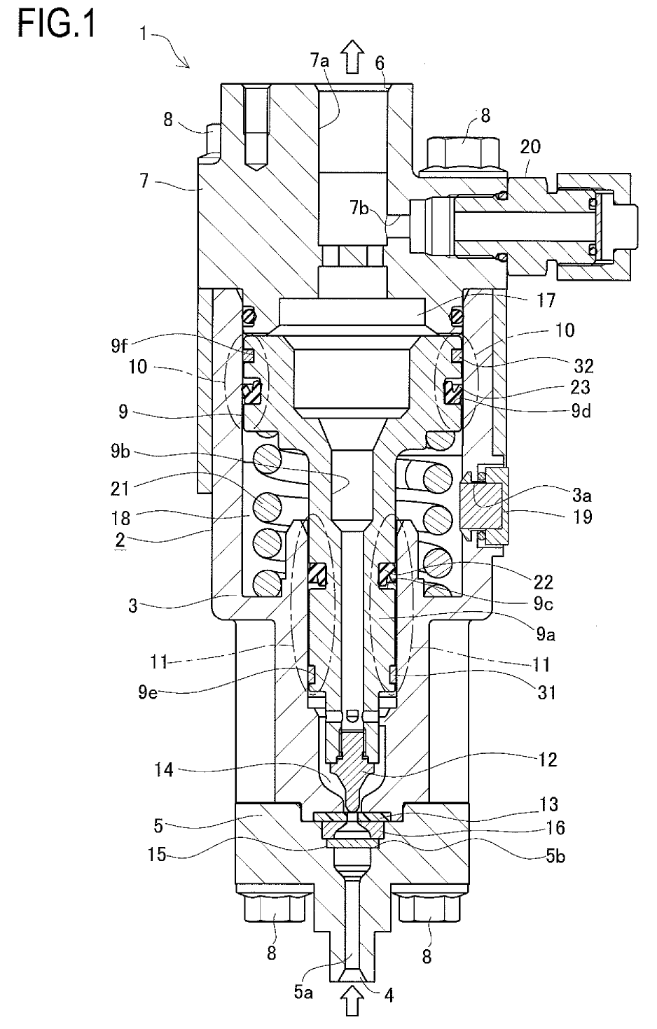

FIG. 1 is a sectional view of a pressure reduction valve 1 of the present embodiment. This pressure reduction valve 1 includes a housing 2. The housing 2 is provided with a metal body case 3, a metal inlet-side case 5 provided with an inlet 4 and placed on an axial one end (on a lower end in FIG. 1) of the housing 2, and a metal outlet-side case 7 provided with an outlet 6 and placed on the axial other end (on an upper end in FIG. 1) of the housing 2. The inlet-side case 5 and the outlet-side case 7 are each fastened by bolts 8 to be fixed to the body case 3.

The body case 3 is formed in a hollow cylindrical shape, and inside the case 3 is provided with a metal piston 9 which is axially movable. On an axial one-end side (on a lower side in FIG. 1) of the piston 9, a rod 9a axially extending toward the inlet 4 is integrally formed. This rod 9a has an outer diameter made to be smaller in its leading end portion than its proximal end portion. In the body case 3, there are formed a piston sliding part 10 (a portion indicated with a chain-dotted elliptical circle in FIG. 1) where a circumferential surface of the piston 9 slides with respect to the case 3 and a rod sliding part 11 (another portion indicated with a chain-dotted elliptical circle in FIG. 1) where a circumferential surface of the rod 9a slides with respect to the case 3.

A leading end of the rod 9a is provided with a valve element 12 having a tapered shape tapering toward its tip end. In corresponding to the valve element 12, a valve seat 13, on which the tip end of the valve element 12 is allowed to be seated (the valve is allowed to be closed), is held between the body case 3 and the inlet-side case 5. The valve seat 13 has a ring-like shaped valve hole in its center and is made separately from the cases 3 and 5 by resin. In the body case 3, a valve chamber 4 is formed downstream of the valve seat 13 and around the valve element 12.

The inlet-side case 5 is formed with an inlet-side passage 5a which communicates with the inlet 4. On an opposite side from the inlet 4, the inlet-side passage 5a includes a step portion 5b changed its passage diameter in a stepwise fashion. This step portion 5b is formed with a metal mesh filter 15 to capture foreign matters in the fluid and a metal bush 16 to hold the filter 15. The bush 16 is held between the filter 15 and the valve seat 13. The valve seat 13 is held between the body case 3 and the inlet-side case 5 as mentioned above, and hence the filter 15 is pressed against the step portion 5b via the bush 16.

A pressure control chamber 17 is provided between the piston 9 and the outlet-side case 7 on a downstream side (on an upper side in FIG. 1) of the piston 9. Further, an air chamber 18 to be communicated with air is provided in a hollow portion of the body case 3 on an upstream side (on a lower side in FIG. 1) of the piston 9. The body case 3 has an air vent 3a on its outer circumference to communicate the air chamber 18 with the air. This air vent 3a is attached with a filter member 19. The outlet-side case 7 includes an outlet-side passage 7a communicated with the outlet 6. The pressure control chamber 17 is communicated with the outlet 6 via the outlet-side passage 7a. The outlet-side case 7 is further provided with a relief valve 20. This relief valve 20 is configured to release the pressure outside when the pressure in the pressure control chamber 17 is excessively increased. An inlet of the relief valve 20 is communicated with the outlet-side passage 7a via a passage 7b.

A piston passage 9b is formed in radial center portions of the rod 9a and the piston 9 to flow fluid from the valve chamber 14 to the pressure control chamber 17. This piston passage 9b is communicated with the valve chamber 14 through a plurality of holes in the vicinity of the valve element 12. The air chamber 18 of the body case 3 is provided with a spring 21 to urge the piston 9 and the rod 9a in a direction to separate the valve element 12 from the valve seat 13.

In the rod sliding part 11, a first lip seal 22 is provided at an outer circumference of the rod 9a. This lip seal 22 is formed in a V-shape in section and fitted in a circumferential groove 9c formed at the outer circumference of the rod 9a. The first lip seal 22 is made of rubber and corresponds to one example of a sealing member. Further, in the piston sliding part 10, a second lip seal 23 is provided at an outer circumference of the piston 9. This lip seal 23 is fitted in a circumferential groove 9d formed at the outer circumference of the piston 9. The second lip seal 23 is made of rubber and corresponds to one example of a second sealing member.

The pressure reduction valve 1 configured as mentioned above is configured such that the fluid introduced through the inlet 4 is flown to the pressure control chamber 17 between the valve element 12 and the valve seat 13 via the piston passage 9b, and when the fluid pressure in the pressure control chamber 17 is balanced with the urging force of the spring 21, the fluid is decompressed and then flown out of the outlet 6.

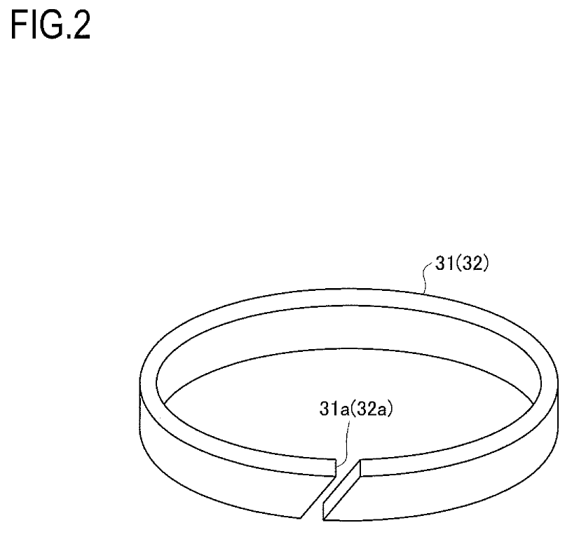

In the rod sliding part 11, a first wear ring 31 to narrow a clearance of the sliding part 11 is provided upstream of the first lip seal 22 at the outer circumference of the rod 9a. The first wear ring 31 is formed in a C-shape and fitted in a circumferential groove 9e which is formed at the outer circumference of the rod 9a. The first wear ring 31 corresponds to one example of a narrowing member. FIG. 2 is a perspective view of the wear ring 31. As shown in FIG. 2, a cut portion 31a of the wear ring 31 is obliquely cut such that both end faces face each other.

In the piston sliding part 10, a second wear ring 32 to narrow a clearance of the sliding part 10 is provided downstream of the second lip seal 23 at the outer circumference of the piston 9. The wear ring 32 is formed in a C-shape and fitted in a circumferential groove 9f which is formed at the outer circumference of the piston 9. The wear ring 32 also has a similar shape to the one shown in FIG. 2. The second wear ring 32 corresponds to one example of a second narrowing member.

According to the pressure reduction valve 1 of the above-mentioned embodiment, the fluid having flown through the inlet 4 flows in the pressure control chamber 17 between the valve element 12 and the valve seat 13 via the piston passage 9b, and when the fluid pressure in the pressure control chamber 17 is balanced with the urging force of the spring, the fluid is decompressed and then flown out of the outlet 6. At this time, the clearance of the rod sliding part 11 is narrowed by the first wear ring 31 on the upstream side of the first lip seal 22, and thus even if the high-pressure fluid suddenly flows from the inlet 4 into the valve chamber 14 and the fluid pressure (inrush pressure) is applied to the rod sliding part 11, the first wear ring 31 relaxes the pressure increase at the first lip seal 22 which is positioned downstream of the first wear ring 31. As shown in FIG. 2, the first wear ring 31 has the cut portion 31a and this cut portion 31a is obliquely cut such that the both ends of the cut portion 31a face each other. Accordingly, when the high-pressure fluid acts on the upstream side (the lower side in FIG. 1) of the first wear ring 31, the wear ring 31 is deformed to bring both ends of the cut portion 31a to join together and to close the cut portion 31a. As a result, it becomes possible to prevent fluid leakage through the cut portion 31a. In other words, the wear ring 31 functions as a labyrinth seal and thus the rod sliding part 11 is enabled to restrict leakage of the fluid. Breakage of the first lip seal 22 in the rod sliding part 11 can be thus prevented, and the sealing function of the lip seal 22 can be ensured. It is therefore possible to prevent the fluid from leaking out of the pressure reduction valve 1. When the pressure reduction valve 1 is used for a hydrogen gas supply device, for example, leakage of the hydrogen gas from the pressure reduction valve 1 can be prevented.

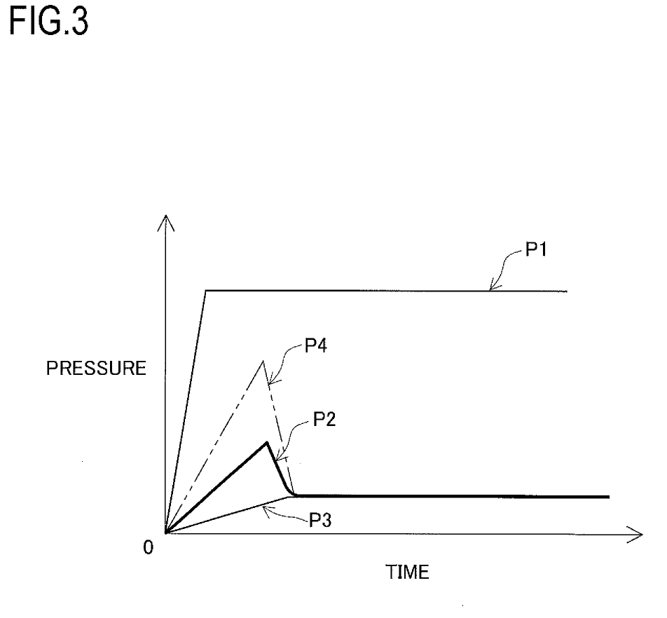

FIG. 3 is a graph showing pressure changes in each part when inrush pressure is applied to the valve chamber 14 of the pressure reduction valve 1. In FIG. 3, “P1” indicates pressure in the inlet 4 (hereinafter referred as inlet pressure), “P2” indicates pressure acting on the first lip seal 22 when the first wear ring 31 is provided (referred as sealing pressure), “P3” indicates pressure in the pressure control chamber 17 (referred as control chamber pressure), and “P4” indicates pressure acting on the first lip seal 22 in a case that the first wear ring 31 is not provided (referred as comparative sealing pressure). As shown in FIG. 3, when the inlet pressure P1 is suddenly increased by the inrush pressure, the sealing pressure P2 is increased more than the control chamber pressure P3 a little later from the increase in the pressure P1. It is however confirmed from the graph that the amount of increase in the pressure P3 is only about a half of the increase amount of the comparative sealing pressure P4. This is because the clearance of the rod sliding part 11 is narrowed by the first wear ring 31 on the upstream side (on the lower side in FIG. 1) of the first lip seal 22, so that the fluid flowing into the first lip seal 22 is reduced, thus delaying the increase in the sealing pressure P2. During that time, when the control chamber pressure P3 reaches a predetermined regulated value, the piston 9 is moved to bring the valve element 12 to be seated on the valve seat 13 for valve closing. This results in equalization of the sealing pressure P2 and the control chamber pressure P3, thereby preventing increase in the sealing pressure P2.

Further, in the present embodiment, the clearance of the piston sliding part 10 is narrowed by the second wear ring 32 on the downstream side (on the upper side in FIG. 1) of the second lip seal 23, and thus even if the high-pressure fluid suddenly flows in the pressure control chamber 17 and the fluid pressure (inrush pressure) is applied to the piston sliding part 10, the pressure increase in the second lip seal 23 which is positioned on the upstream side (on the lower side in FIG. 1) of the second wear ring 32 can be relaxed. Accordingly, it is possible to prevent breakage of the second lip seal 23 in the piston sliding part 10, thus ensuring the sealing function of the lip seal 23. Also from this consequence, it is possible to prevent the fluid from leaking out of the pressure reduction valve 1.

### Second Embodiment

A second embodiment embodying a pressure reduction valve of the present invention is now explained in detail with reference to the accompanying drawings. In the foregoing explanation, similar components with the first embodiment are indicated with the same referential signs with the first embodiment, and explanation thereof is omitted. The following explanation is made with a focus on the differences from the first embodiment.

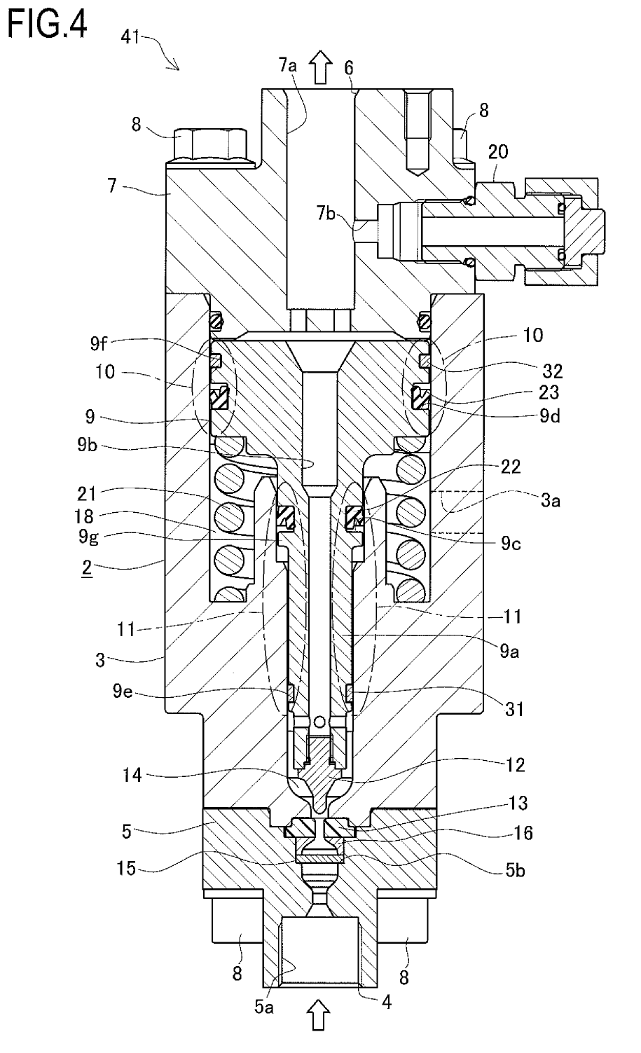

FIG. 4 is a sectional view showing a pressure reduction valve 41 of the present embodiment. The pressure reduction valve 41 of the present embodiment is different from the pressure reduction valve 1 of the first embodiment mainly in its configuration of the rod 9a. In the pressure reduction valve 41 of the present embodiment, the rod 9a has an almost same outer diameter from a proximal end portion to a leading end portion. Further, in the present embodiment, the narrowing member provided in the rod sliding part 11 includes the first wear ring 31 and a flange 9g formed at an outer circumference of the rod 9a on the downstream side of the ring 31. The flange 9g is placed near the first lip seal 22. This flange 9g also functions as the labyrinth seal to narrow the clearance of the rod sliding part 11 so that communication of the fluid is restricted.

According to the present embodiment, the clearance of the rod sliding part 11 on the upstream side (on the lower side in FIG. 4) of the first lip seal 22 is narrowed in two stages of the first wear ring 31 and the flange 9g, and thus even if the high-pressure fluid suddenly flows from the inlet 4 into the valve chamber 14 and the fluid pressure (inrush pressure) is applied to the rod sliding part 11, the pressure increase in the first lip seal 22 is relaxed in the two stages of the first wear ring 31 and the flange 9g. Accordingly, breakage of the first lip seal 22 in the rod sliding part 11 can be further surely prevented, and the sealing function of the lip seal 22 can be ensured.

### Third Embodiment

Next, a third embodiment embodying a pressure reduction valve of the present invention is explained in detail with reference to the accompanying drawings.

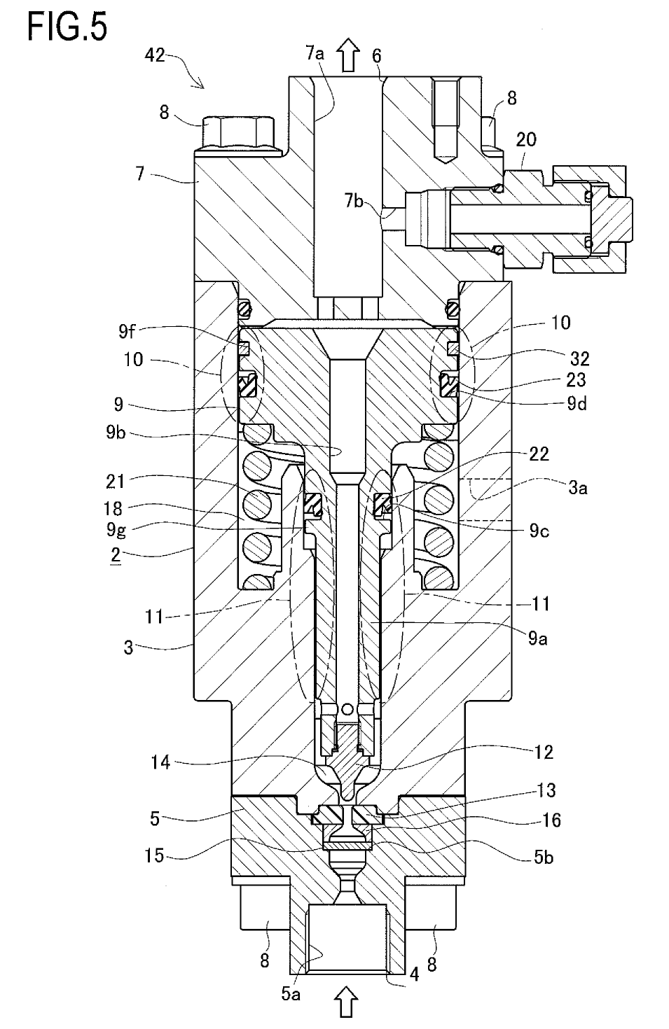

FIG. 5 is a sectional view of a pressure reduction valve 42 in the present embodiment. The pressure reduction valve 42 of the present embodiment is different from the pressure reduction valve 41 in the second embodiment in the configuration that the first wear ring 31 is not provided.

In the present embodiment, even though the first wear ring 31 is not provided, the clearance of the rod sliding part 11 is narrowed by a flange 9g on the upstream side (on the lower side in FIG. 5) of the first lip seal 22. Thus, even if the high-pressure fluid suddenly flows from the inlet 4 into the valve chamber 14 and the fluid pressure (inrush pressure) is applied to the rod sliding part 11, the pressure increase in the first lip seal 22 on the downstream side (on the upper side in FIG. 5) of the flange 9g is relaxed. Accordingly, breakage of the first lip seal 22 in the rod sliding part 11 is prevented and the sealing function of the lip seal 22 can be ensured.

The present invention is not limited to the above embodiments and may be partly applied with various changes without departing from the scope of the subject matter.

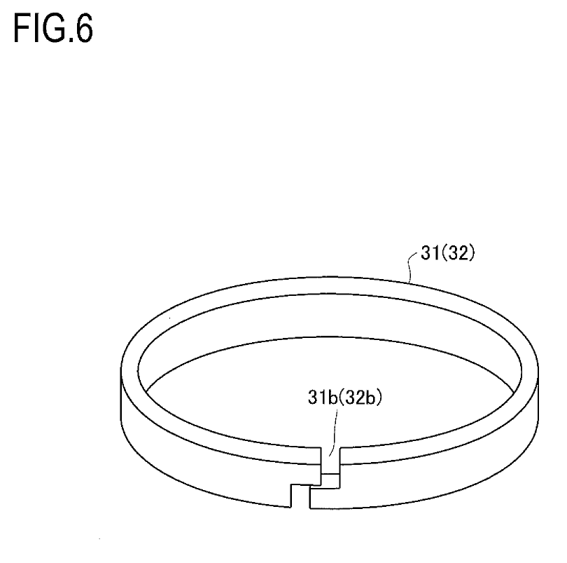

In the above first and second embodiments, the first and second wear rings 31 and 32 are obliquely cut in the cut portions 31a and 32a, respectively, such that the both end faces of each of the cut portions 31a and 32a face each other. As one alternative for this, as shown in a perspective view of FIG. 6, the first and second wear rings 31 and 32 may be cut in a stair-like shape in the cut portions 31b and 32b such that the both end faces of each of the cut portions 31b and 32b face each other.

In the above embodiments, the first and second lip seals 22 and 23 are provided as sealing members, but the sealing member is not limited to the lip seal and may be any other component which enables to ensure sealing function of the sliding part.

In the above embodiments, the piston 9 and the rod 9a are integrally formed, but alternatively, these elements may be individually formed and then joined together.

In the above embodiments, the rod 9a and the valve element 12 are separately formed, but alternatively, the rod 9a and the valve element 12 may be integrally formed.

### INDUSTRIAL APPLICABILITY

The present invention can be utilized for a fluid supply device to decompress and supply high-pressure fluid such as high-pressure gas. One example of the fluid supply device is a hydrogen supply device to supply hydrogen gas to a fuel cell.

### REFERENCE SIGNS LIST

1 Pressure reduction valve

2 Housing

4 Inlet

6 Outlet

9 Piston

9a Rod

9b Piston passage

10 Piston sliding part

11 Rod sliding part

12 Valve element

13 Valve seat

14 Valve chamber

17 Pressure control chamber

21 Spring

22 First lip seal (sealing member)

23 Second lip seal (second sealing member)

31 First wear ring (narrowing member)

32 Second wear ring (second narrowing member)

What is claimed is:

1. A pressure reduction valve including:
a housing;
an inlet and an outlet provided on an axial one end and the other end of the housing, respectively;
a piston provided in the housing in an axially movable state;
a rod axially extending from the piston toward the inlet;
a rod sliding part along which the rod is configured to slide with respect to the housing;
a valve element provided on a leading end of the rod;
a valve seat configured to be seated with the valve element in the housing;
a valve chamber formed around the valve element downstream of the valve seat;
a pressure control chamber provided between the piston and the housing on a downstream side of the piston to communicate with the outlet;
a passage formed in the rod and the piston to flow fluid from the valve chamber to the pressure control chamber;
a spring configured to urge the piston and the rod in a direction to separate the valve element from the valve seat; and
a sealing member provided on the rod sliding part,
the pressure reduction valve being configured such that fluid introduced from the inlet is flown in the pressure control chamber between the valve element and the valve seat via the passage and when the fluid pressure in the pressure control chamber is balanced with the urging force of the spring, the fluid is decompressed and then flown out of the outlet, wherein
the pressure reduction valve further includes a narrowing member placed upstream of the sealing member to narrow a clearance between the rod sliding part and the housing.

2. The pressure reduction valve according to claim 1, wherein the narrowing member includes a wear ring provided at an outer circumference of the rod.

3. The pressure reduction valve according to claim 1, wherein the narrowing member includes a flange formed at an outer circumference of the rod.

4. The pressure reduction valve according to claim 1, wherein the narrowing member includes a wear ring provided at an outer circumference of the rod and a flange formed at an outer circumference of the rod on a downstream side of the wear ring.

5. The pressure reduction valve according to claim 1, wherein
the pressure reduction valve includes:
a piston sliding part along which the piston is configured to slide with respect to the housing;
a second sealing member provided on the piston sliding part; and
a second narrowing member placed downstream of the second sealing member to narrow a clearance between the piston sliding part and the housing.

6. The pressure reduction valve according to claim 2, wherein
the pressure reduction valve includes:
a piston sliding part along which the piston is configured to slide with respect to the housing;
a second sealing member provided on the piston sliding part; and
a second narrowing member placed downstream of the second sealing member to narrow a clearance between the piston sliding part and the housing,

7. The pressure reduction valve according to claim 3, wherein
the pressure reduction valve includes:
a piston sliding part along which the piston is configured to slide with respect to the housing;
a second sealing member provided on the piston sliding part; and
a second narrowing member placed downstream of the second sealing member to narrow a clearance between the piston sliding part and the housing.

8. The pressure reduction valve according to claim 4, wherein
the pressure reduction valve includes:
a piston sliding part along which the piston is configured to slide with respect to the housing;
a second sealing member provided on the piston sliding part; and
a second narrowing member placed downstream of the second sealing member to narrow a clearance between the piston sliding part and the housing.

9. The pressure reduction valve according to claim 5, wherein the second narrowing member includes a second wear ring provided at an outer circumference of the piston.

10. The pressure reduction valve according to claim 6, wherein the second narrowing member includes a second wear ring provided at an outer circumference of the piston.

11. The pressure reduction valve according to claim 7, wherein the second narrowing member includes a second wear ring provided at an outer circumference of the piston.

12. The pressure reduction valve according to claim 8, wherein the second narrowing member includes a second wear ring provided at an outer circumference of the piston.
